(19) United States
(12) Patent Application Publication
(10) Pub. No.: US 2012/0105181 A1
(43) Pub. Date: May 3, 2012

(54) SYSTEMS FOR PRODUCING GRAVITY-NEUTRAL REGIONS BETWEEN MAGNETIC FIELDS, IN ACCORDANCE WITH ECE-THEORY

(75) Inventor: Charles W. KELLUM, Alexandria, VA (US)

(73) Assignee: GALACTICAN GROUP, Alexandria, VA (US)

(21) Appl. No.: 13/341,229

(22) Filed: Dec. 30, 2011

Related U.S. Application Data
(63) Continuation-in-part of application No. 12/879,954, filed on Sep. 10, 2010.
(60) Provisional application No. 61/241,249, filed on Sep. 10, 2009.

(51) Int. Cl. H01F 7/20

(52) U.S. Cl. 335/285

(57) ABSTRACT

Methods and systems for creating a local anti-gravity region are defined. The anti-gravity region is created between two counter-rotating magnetic fields. The magnetic field sources can be permanent magnets, magnetized material, or a combination of both. Matter in the induced anti-gravity region obviously behaves as in a zero-gravity environment, such as outer space. Processes conducted in the anti-gravity region can experience increased efficiency. The anti-gravity effect is generated by the electromagnetic fields, of the counter-rotating magnetic sources, resonating with the torsion of spacetime. This resonance causes the potential of the electromagnetic fields to be amplified, maximizing the effect of the electric field in a direction opposite to gravitation. This anti-gravity effect is in accordance with the new ECE (Einstein-Cartan-Evans)-Theory of physics. ECE-Theory shows gravitation and electromagnetism are both defined as manifestations of the curvature of spacetime.

### 1. BACKGROUND OF THE INVENTION

### Field of the Invention

This invention relates to systems for generating an anti-gravity region between magnetic fields. This application is a continuation-in-part of;
METHODS & SYSTEMS FOR GENERATING A GRAVITY-NEUTRAL REGION BETWEEN TWO COUNTER-ROTATING MAGNETIC SOURCES, IN ACCORDANCE WITH ECE-THEORY by Charles Kellum
   the entire teachings of which are contained herein by reference.

Electromagnetic forces are created, configured, and aligned so as to generate an anti-gravity effect.

Such an anti-gravity effect is caused by the change in curvature of spacetime. Gravitation is the curvature of spacetime. Electromagnetism is the spinning (or torsion) of spacetime. By properly amplifying the interaction between these forces, anti-gravity effects can be produced. Obviously, the magnetic sources can be viewed as magnetized matter. Their interaction is used to induce spacetime curvature, thus creating an anti-gravity effect. This process can have applications ranging from electric power generation, to vehicular propulsion. A primary application of the invention is a demonstration of Einstein-Cartan-Evans (ECE)-Theory principles. ECE-Theory principles include anti-gravitation via interaction between forces.

### 1.1 Introduction

Electromagnetic radiation is the basis by which we perceive and measure phenomena. All of our human experiences and observations rely on electromagnetic radiation. Observing experiments and phenomena perturb electromagnetic radiation. Our observations and measurements sense the resulting perturbations in electromagnetic fields. This realization has far reaching ramifications, ranging from our basic perceptions of the universe, to our concepts of space, time, and reality.

As a starting point, the Special Theory of Relativity postulates that the speed-of-light (c), is the maximum velocity achievable in our spacetime continuum. A more correct statement, of this result of Einstein's ingenious theory, is that c is the greatest observable velocity (i.e. the maximum velocity that can be observed) in our spacetime. This is because c (the natural propagation speed of electromagnetic radiation) is our basis of observation. Phenomena moving at speeds ≧c cannot be normally observed using electromagnetic radiation. Objects/matter moving at trans-light or super-light velocities will appear distorted or be unobservable, respectively. A brief analytical discussion of these factors is given below, in following sections. This is the first, of the two primary principles, exploited in this document.

The second principle is that electromagnetism and gravitation are both expressions of spacetime curvature. Stated from the analytical perspective, electromagnetism and gravitation are respectively the antisymetric and symmetric parts of the gravitational Ricci Tensor. Since both the electromagnetic field and the gravitational field are obtained from the Riemann Curvature Tensor, both fields can be viewed as manifestations/expressions of spacetime curvature. This principle is proven in several works, some of which are listed in section 1.1.1 below.

### 1.1.1 Applicable Documents

[1] “Gravitation and Cosmology” Principles & Applications of the General Theory of Relativity By: Steven Weinberg, MIT John Wiley & Sons, Inc, 1972
[2] “Gravitation” By: C. Misner, K. Thorne, J. Wheeler W. H. Freeman & Co., 1973
[3] “Why There is Nothing Rather Than Something” (A Theory of the Cosmological Constant) By: Sidney Coleman Harvard University, 1988
[4] “Superstring Theory” Vols. 1 & 2 By: M. Green, J. Schwarz, E. Witten Cambridge University Press, 1987
[5] “Chronology Protection Conjecture” By: Steven W. Hawking University of Cambridge, UK 1992
[6] “The Enigmatic Photon” Vol. 1: The Field B⁽³⁾ Vol. 2: Non-Abelion Electrodynamics Vol. 3: Theory & Practice of the B⁽³⁾ Field By: M. Evans, J. Vigier Kluwer Academic Publishers, 1994-1996
[7] “The B⁽³⁾ Field as a Link Between Gravitation & Electromagnetism in the Vacuum” By: M. Evans York University, Canada 1996
[8] “String Theory Dynamics in Various Dimensions” By: Edward Witten Institute for Adv. Study; Princeton, N.J. 1995
[9] “Can the Universe Create Itself?” By: J. Richard Gott III, Li-Xin Li Princeton University, 1998
[10] “Concepts and Ramifications of a Gauge Interpretation of Relativity” By: C. Kellum; The Galactican Group, USA AIAS posting; April 2008
[11] “Physical Theory of the Levitron” By; H. Eckardt, C. Kellum AIAS posting; 17 Sep. '10
[12] “The Levitron™: A Counter-Gravitation Device for ECE-Theory Demonstration” Revision 1 By: Charles W. Kellum The Galactican Group July 2010
[13] “Generally Covariant Unified Field Theory” By; M. W. Evans Abramis, Suffolk, (2005 onwards)
[14] “The Spinning and Curving of Spacetime; The Electromagnetic & Gravitational Field in the Evans Unified Field Theory” By; M. W. Evans AIAS 2005
[15] “Spacetime and Geometry; An Introduction to General Relativity” By; Sean M. Carroll Addison Wesley, 2004 ISBN 0-8053-8732-3
[16] “Spin Connected Resonances in Gravitational General Relativity” By; M. W. Evans Aeta. Phys. Pol. B, vol. 38, No. 6, June 2007 AIAS (UFT posting [64])
[17] “Spin Connected Resonance in Counter-Gravitation” By; H. Eckardt, M. W. Evans AIAS (UFT posting [68])
[18] “Devices for Space-Time Resonance Based on ECE-Theory” By; H. Eckardt AIAS posting 2008
[19] “ECE Engineering Model, version 2.4, 18 May '09” By; H. Eckardt AIAS posting 2009
[20] “The Resonant Coulomb Law of ECE-Theory” By; M. W. Evans, H. Eckardt AIAS (UFT posting [63])
[21] “Theoretical Discussions of the Inverse Faraday Effect, Raman Scattering, and Related Phenomena” By; P. Pershan, J. van der Ziel, L. Malmstrom (Harvard Univ.) Physical Review vol. 143, No. 2, March 1965
[22] “Description of the Faraday Effect and Inverse Faraday Effect in Terms of the ECE Spin Field” By; M. W. Evans AIAS (UFT posting [81]) 2007
[23] “Curvature-Based Vehicular Propulsion”; (Rev. 2) By; Charles Kellum The Galactican Group; USA (WP06) May 2011
[24] “Anti-Gravity Device Demonstration Video” (Crossfield-Device (CFD) Working Model) By: C. W. Kellum; W. Stewart The Galactican Group, USA 13 May 2010
[25] “Electric Power Generation from Spacetime Background Potential Energy”; (Rev. 2) By; Charles Kellum The Galactican Group; USA (WP07) May 2011

### 1.1.2 Overview

The above cited (and related) works also raise fundamental issues as to the origin, dynamics, and structure of our spacetime continuum. Our universe appears to be dynamic in several parameters. It is suggested that the results arrived at in this document might shed some small light on a few of said fundamental issues. Please note that boldface type indicates a vector quantity, in the remainder of this document; example (v implies the vector quantity \vec{v}).

The objective here is to describe/present a new method of, and system for, propulsion. This method is based on utilizing the equivalence of electromagnetism and gravity by inducing local spacetime curvature. The induced curvature results in a geodesic curve. The “propulsion phase” involves a “fall” along said geodesic curve. The basic definition for a geodesic is (in the context of gravitational physics), from [2]:
—a curve that is straight and uniformly parameterized as measured in each local Lorentz frame (coordinate system at a point of the curve) along its way. (where a “curve” is a parameterized sequence of points)
—as a general definition, a geodesic is a free-fall trajectory, which is the shortest path between two points, wherein said points are on some metric-space.

The process is called “geodesic-fall”. The “geodesic-fall vector” is denoted as [symbol] . The “geodesic-fall” process requires the generation of a proper electromagnetic field to induce local spacetime curvature and, fall along the resulting geodesic curve. The vehicle/particle under “geodesic-fall” moves along the geodesic curve at a velocity dependant on the degree of induced curvature. Theoretically, the maximum achievable velocity is determined by curvature. The maximum achievable velocity is not limited by c (the speed-of-light) in normal/unperturbed spacetime. Under The “geodesic-fall” process, the primary constraints on velocity are due to the degree of induced curvature, and to the structure of the vehicle.

### 1.2 Basic Concepts

Trans-light and super-light speeds have long been the domain of the science fiction community. In recent years, serious cosmologists and theoreticians have examined this arena. Below is presented a generalized view of the Special Relativity Theory. One starts with a regional structure of spacetime.

### 1.2.1 Regions of Spacetime

It has been suggested (for example in [9], by some string-theorists, etc.) that the “Big Bang” was a local phenomena, and that other “Big Bang” type phenomena events might be observable in distant reaches of our known universe. Additionally, many of the theoretical problems with the “Big Bang theory” (primary among which is causality), can be solved by considering a regional structure of spacetime. Depending on the size of the regions, a “Big Bang” event could be viewed as a local phenomenon.
Below in this document, an arbitrary region of spacetime is examined and equations-of-motion (based on a generalized parameter of said region) are derived, so as to develop a generalized view of Special Relativity.
   A regional view of spacetime can offer several analytical advantages and some ramifications. For this work, one can consider our known spacetime as a “region” of the universe. Under this framework, certain phenomena encountered by astro-physicists and cosmologists might be accounted for through boundary conditions of our spacetime region. Black holes, and the possible variance of c, are examples of such phenomena.

Further, if the “Big Bang” is a local phenomenon, this reality would suggest that the universe has always existed. Coupled with aspects of M-Theory, a regional structure of the universe makes it not unreasonable to consider the universe without a specific origin, as one contemplates the definition of origin in this context. It is possible that the universe has always existed. Additionally, observed background radiation could be accounted for as inter-regional energy exchange.

### 1.2.2 Velocity

To examine constraints on velocity, using geodesic-fall [symbol] , it is useful to begin by deriving a generalized view of Special Relativity. An arbitrary region λ of spacetime will be examined. This could conceivably be our region/sub-universe/brane of existence. A generalized parameter of this region will also be used. Let this generalized parameter Φ be defined as the maximum natural velocity (i.e. energy speed of propagation) in this region. Then one can derive the concepts of Special Relativity, based on parameter Φ_{λ} in region λ.

For the purpose of this document (and to attempt leeward bearing to other naming conventions) the generalized derivation [10] is referred to as the Light Gauge Theory (LGT). In this context “gauge” is defined as a standard of measurement, or a standard of observation. Additionally, the speed-of-light c, will also denote the velocity (vector) c. Thus, both the speed & velocity-of-light are denoted by c, for notational simplicity in this document.

The term “neighborhood” should be understood as the immediate volume of spacetime surrounding (and containing) the point, particle, or vehicle under discussion, in the context of this document.

### 1.2.2.1 The Light Gauge

Given:

Two observers a distance x apart in a region λ of spacetime. An event happens at observer A's position, at time t, (x₁, x₂, x₃, t). The observer B, at position (x′₁, x′₂. x′₃, t′) also observes the event that happens at A's position.

### Let:

—v_{λ} define the maximum propagation speed of signals in region λ
—v_{λ}>c, v_{λ}>c_{λ}
   This is a counter assumption that c is not necessarily universal, and that c_{λ} is not the maximum speed a signal can propagate in spacetime region λ. Two viewpoints/arguments are considered:

1. The maximum signal velocity, in a spacetime region, is unbounded (i.e. ∞)

2. The maximum signal velocity, in a spacetime region, cannot exceed some Φ in that spacetime region, (e.g. Φ_{λ}, for the spacetime region λ). One states that Φ_{λ}≠c_{λ}, can be viewed as the general case.

### Argument 1;

This 1^{st} viewpoint would imply instantaneous synchronization, and the observable simultaneity of diverse events. Instantaneous propagation is an oxymoron. It does not follow observable (or analytical) analysis.

### Argument 2;

This 2^{nd} viewpoint involves deriving a Lorentz transformation for a spacetime region. One then defines an inter-region transformation for observers in different spacetime regions, where the regions are sub-manifolds on the general Riemann Manifold of spacetime.

### 1.2.2.1.1 Modified Lorentz Transformation

For the remainder of this document, I consider the set of spacetime regions that are definable as sub-manifolds on the Riemann Manifold of spacetime. The Theory of General Relativity describes physical space (i.e. our spacetime region) as a manifold.

One considers, in spacetime region/(sub-manifold) λ, two observers moving relative to each other, at velocity v. For notational simplicity, one observer will be in an unprimed coordinate system, (xᵢ, tᵢ). The other observer is in a primed coordinate system, (x′ᵢ, t′ᵢ). One “assumes” (as in Special Relativity) that, at the origin of each reference frame, x=0, t=0.

Let:

x′=αx+v(βv·x+κt)

t′=ζv·x+ηt

α, β, κ, ζ, η fall from the pre-relativistic equations x′=x+vt, and t′=t Thus, α, κ, η approximate 1, and β, ζ approximate 0, when v<Φ_{λ}. One defines c_{λ} as the speed of light in spacetime region λ. Let c_{λ}<Φ_{λ}. If one assumes (according to Relativity) that the speed of light is constant, one has c_{λ}=c<c_{λ}.

If the primed coordinate system has a velocity v, in the unprimed coordinate system, and the unprimed coordinate system has velocity v in the primed coordinate system, one has the following;

If x′=0, then x=−vt and if x=0, then x′=vt′

$$\begin{matrix}0 = - α vt + v ( β v \cdot vt + κ t ) \\ = - α vt + κ vt - β {v}^{2} \cdot {vt}^{2}\end{matrix}$$

α=§−βv²

t′=ζv·x+ηt

t′=−ζv·vt+ηt

ηt=ζv²t, (where η=ζ for proper values of v²)

One can now discuss the maximum signal velocity (Φ_{λ}), possible in the λ region of spacetime. Assume that this maximum is universal, in the λ region of spacetime. In other words, (Φ_{λ}) is the maximum attainable signal velocity in the λ region of spacetime, irrespective of the observer's coordinate system.

### Note;

1. Here, the λ region of spacetime is defined as a sub-manifold on the (general spacetime) Riemann Manifold.
2. Assume that Φ_{λ} is a function of the curvature of spacetime region λ.

### 1.2.2.1.1.1 Length Contraction

x′₂−x′₁=(x₂−x₁)/(1−β²)^{1/2}

thus, an object measures shorter in coordinate system ξ′, when observed from coordinate system ξ, if ξ′ is in motion relative to ξ.

### 1.2.2.1.1.2 Time Dilation

t₂−t₁=(t′₂−t′₁)/(1−β²)^{1/2}

### 1.2.2.1.2 Conclusions

By the above transformations, where β=v/Φ_{λ}, a particle moving at velocity v≧Φ_{λ} drives the transformation equations to infinity. Thus, in any given spacetime region λ, v≧Φ_{λ} implies the particle is not observable in region λ, when measured by signals propagating (in region λ) at velocities v_{λ}<Φ_{λ}.

### 1.2.3 Φ_{λ} and Curvature

Einstein intuitively chose c (the natural speed of electromagnetic wave propagation in our spacetime region) to be the Φ_{λ} of his derivations. This was apparently an intuitive choice, since the speed of light is the highest “natural velocity” observed in our spacetime region. One can state that c is a special case of the general case Φ_{λ}. Also, for the generalized case, Φ_{λ} can be greater than c.

For this work, the “natural speed” is defined as the velocity of propagation of electromagnetic energy along a geodesic. Since a geodesic curve is the result of spacetime curvature, the “natural speed” is arguably dependent on the curvature of spacetime. Thus, given a regional structure of spacetime, the curvature θ_{λ} of region λ determines Φ_{λ}. Then

θ_{λ}=>c_{λ}(θ_{λ}) is a function of curvature.

This implies that the “generalized natural speed” is dependant on the curvature. For any spacetime region i, Φᵢ(θᵢ); where θᵢ is the curvature of region i.

### 1.3 Spacetime Regions

### Some Possible Ramifications

If (as a brief aside) one examines a regional structure of spacetime, several factors might follow.

The regions of spacetime, if dynamic (in size and/or other properties), could account for several phenomena (both observed and predicted). Considering the curvature parameter, if one examines regional curvature, as the regions become smaller;
Let:
   Wᵢ=volume of the i^{th} region of spacetime

$$\begin{matrix}{λ}_{i} = curvature of the {i}^{th} region of spacetime \\ = f ( {W}_{i}^{′} … )\end{matrix}$$

∂λᵢ/∂Wᵢ=∂f(Wᵢ′ . . . )dqᵢ/∂Wᵢ,
where qᵢ is a generalized coordinate
Then:

$${limit f}_{Wi \to 0} ( {W}_{i}^{′} … ) = {limit {λ}_{i}}_{Wi \to 0} \approx$$

Where K is an approximation of curvature/gravity in a quantum framework?
   It is interesting to note that, where Wᵢ approaches the Planck-Scale, neither Relativity nor Quantum Theory accurately predicts the behavior of matter.

By the Theory of General Relativity, all of space is a manifold. Therefore one can consider regions as submanifolds of spacetime. A region of spacetime is a set of points. If one considers regional curvature (i.e. curvature of a given region of spacetime) as a “relation or operation” on the set of points defining a region, then the curvature operation arguably has transitivity, identity (i.e. flat/zero-curvature), and an inverse (i.e. negative curvature) on the points of said region. The region can then be called a group. Since the region is a manifold, the region is also a lie-group. Generalizing, one can view spacetime as a set of lie-groups.

Regions containing singularities (e.g. black holes) could be analyzed using the orbitfold-based arguments of M-Theory. This might also be useful in analysis of regional boundary conditions. A “regional structure” of spacetime would mean that a given region is bounded by a set of other regions. Thus, obviously, the boundary conditions of a given region would be a summation of its sub-boundaries with members of its set of bounding/connecting regions. An orbitfold-based approach might be useful in analyzing such boundary conditions, as well as regional singularities (e.g. black holes). The main suggestion here is, given region size, the same analysis methods might hold, whether micro or macro regions are considered. Conceptually, macro-regions could be described using the “brane” structure of M-Theory. Micro-regions could be used to describe quantum behavior/properties of curvature. As region size “theoretically” approaches zero, regional size encounters the Planck-Scale. Below the Planck-Scale, present knowledge prevents accurate prediction of behavior.

Descriptions of curvature/gravity (under a regional structure) might therefore offer a way to incorporate a quantum framework that includes gravity, when micro-regions are considered.

### 1.4 Summary

The cursory discussion of this section 1, establishes the conceptual background of the invention. A second objective of this background section is to suggest a possible approach to the problem of incorporating gravity into a quantum framework. Some additional considerations might be useful. They are as follows;
(1) Photon behavior is described, as to the “view of an observer”, in a local coordinate-system (i.e. reference-frame). If spacetime consists of regions, then a region around a black hole has its own preferred reference frame.
(2) A Postulate: Regions of spacetime might have different properties. Thus, they might have preferred local frames-of-reference (i.e. coordinate systems). If so, a particular region, depending on its curvature (and size) might accommodate Relativity or Quantum Theory. This could form the basis for a Quantum Theory of Gravity/(spacetime-curvature).
   The focus of the remainder of this document is our spacetime region, its curvature, its torsion, and resulting applications such as geodesic-fall [symbol] , in our region of spacetime.

### 2. SUMMARY OF INVENTION

The invention is an anti-gravity device. It is based on the new ECE-Theory of cosmology. The ECE (Einstein-Cartan-Evans)-Theory [13-15] is a generally covariant unified field theory, developed by Prof. Myron W. Evans in 2003. A major principle of the ECE-Theory is that electromagnetism and gravitation are both manifestations of spacetime curvature. More specifically, electromagnetism is the torsion of spacetime, and gravitation is the curvature of spacetime. Since torsion can be viewed as spin, one concludes that spacetime has both curvature and spin. The spinning/torsion of spacetime was neglected in Einstein's Theory of Relativity. Einstein also arbitrarily (and incorrectly) assumed c (the speed of light) could not be exceeded. The ECE-Theory also shows that coupling between the background potential of spacetime can be established by appropriate electrical and/or mechanical devices. This coupling manifests as amplification of the potential (in volts) of such devices, as said devices resonate with the background potential energy of spacetime. This phenomenon is called spin-connection-resonance (SCR), [16, 17]. Some engineering principles, for such devices, are discussed in [18]. The invention is a device that employs some of the engineering concepts discussed in [18]. One purpose of the invention is to demonstrate SCR and other principles of ECE-Theory. Fundamentally, ECE-Theory is a combination of Einstein's geometric approach and Cartan Geometry to describe the nature & structure of spacetime. Cartan Geometry [15] adds torsion to the Riemann Geometry used by Einstein in his Theory of Relativity. Thru ECE-Theory, electromagnetism can be expressed as the torsion of spacetime. The basic set of ECE-Theory equations describes both gravitation and electromagnetism.

### 2.1 Basic Concepts

In general, to counter the gravitational field of spacetime (i.e. at a given point in spacetime), the potential energy (Φ) of spacetime, must be increased. Using ECE-Theory, the background potential energy of spacetime (i.e. the scalar potential Φ) is considered.

### Background Potential Energy of Spacetime Φ

Conventionally, gravitational potential energy is related to the gravitational force. Gravitational potential energy (K), of an object is;

K=mgh
Where;→
   m=mass of object
   g=gravitational acceleration
   h=altitude above earth
      If an object's altitude above the earth decreases its, K decreases. If an object's altitude above the earth increases its, K increases.

From ECE-Theory, considering that gravitation & electromagnetism are both expressions of spacetime curvature (where gravitation is the curvature of spacetime and electromagnetism is the torsion/twisting of spacetime), K≡Φ can be viewed as related to spacetime curvature. Thus, the gravitational potential energy (at any point in spacetime), can be regarded as the potential energy experienced by an object at that point. The curvature (i.e. gravitational field) of spacetime at any point, determines the geodesic-path and velocity an object (at that point) would experience. If curvature was induced at a point in spacetime, an object at that point could fall along the resulting geodesic, at a velocity dependant on the degree of said induced curvature. This induced geodesic-fall vector would be different from the natural geodesic-fall vector (e.g. normal gravity, in the earth realm). In the earth realm, raising the altitude of an object opposes gravity (i.e. induces spacetime curvature) and increases the object's potential energy. Therefore, by increasing Φ, anti-gravity effects can be induced.

The ECE-Theory shows [16, 17] that coupling between the background potential energy (Φ) of spacetime, can be established with appropriate electrical and/or mechanical devices. This coupling can cause a significant increase in Φ (in the neighborhood of such a device). Thus, gravitation is countered in that device neighborhood. The field equations of ECE-Theory are used below, to show (analytically) how this coupling works.

### Spin-Connection Resonance (SCR)

ECE-Theory shows that properly designed electric and/or mechanical devices can resonate with Φ. The ECE field equations can be used to define an engineering framework for the design & implementation of devices suitable for coupling with the background potential energy (Φ) of spacetime (i.e. achieving SCR).

### Engineering Framework (for an SCR Capable Device Technology)

From the form of a general resonance equation (i.e. differential equation) for generalized item qᵢ(x), where f(x) is the driving function, we have:

∂²qᵢ(x)/∂x²+ζ₁∂qᵢ(x)/∂x+ζ₂qᵢ(x)=f(x)

From the ECE-Theory field equations (where boldface denotes a vector quantity, ∇ is the gradient vector), the following relations are used;

E=−∂A/∂t−∇Φ−ω₀A+Φω

B=∇×A−ω×A
where;

$$\to \{ \begin{matrix}A = vector potential of spacetime \\ φ = scalar “ “ \\ {ω}_{0} = “ spin connection \\ ω = vector “ “\end{matrix}$$

Considering the electrical case, from [18] we let A=0, which gives the following:

E=−∇Φ+Φω

Using Coulomb Law (∇·E=ρ/∈₀), we have:

$$\begin{matrix}∇ \cdot E = \frac{ρ}{{ɛ}_{0}} \\ = ∇ \cdot ( - ∇ φ + φω ) \\ = - ∇ \cdot ∇ φ + ω \cdot ∇ φ + φ ∇ \cdot ω \\ = - {∇}^{2} φ + ω \cdot ( ∇ φ ) + ( ∇ \cdot ω ) φ\end{matrix}$$

Multiplying by (−1), we have;

$$= {∇}^{2} φ - ω \cdot ( ∇ φ ) - ( ∇ \cdot ω ) φ \\ = \frac{ρ}{{ɛ}_{0}}$$

The ECE Coulomb Law thus gives the expression:

∇²Φ−ω·(∇Φ)−(∇·ω)Φ=−ρ/∈₀

This is a resonance equation for Φ, the scalar potential. The resonant frequency is (∇·ω), the divergence of the spin connection [18]. Thus the term spin-connection-resonance (SCR), is used. If Φ is the spacetime scalar potential, then at SCR, Φ should be maximized. The effect is to induce spacetime curvature in the maximized potential field Φ. The degree of induced curvature, and the resulting geodesic path are determined by the driving function (−ρ/∈₀). The induced curvature & resulting geodesic path would be different from the natural curvature & geodesic path. Thus, natural gravity is opposed. Fundamentally, by increasing (e.g. maximizing) spacetime gravitational potential energy Φ, anti-gravity effects are generated.

### Driving Function Principles for SCR Capable Devices & Systems

From [18], and observation an engineering approach to a device family for coupling with Φ is suggested. Given, that the resonance frequency from eq. (7) is (∇·ω), and ω is a rotation vector of a magnetic field, it is reasonable to consider devices based on rotating magnetic fields. A rotating magnetic field (or two counter-rotating magnetic fields [18]) can be used to achieve resonance, SCR in this case. At SCR, Φ is amplified in the neighborhood of the rotating magnetic fields. Gravitation is countered, and electric energy is available ([18]. The remaining focus of this document will be counter-gravitation devices, based on counter-rotating magnetic fields. Such devices can be referred to as cross-field devices.

### 2.2 Spin Connection Resonance (SCR) Effects

The ECE-Theory allows the interaction of the electromagnetic field and the gravitational field. A generally covariant unified field theory, such as ECE-Theory, allows such interaction. This field interaction is defined in [17]. The significance of ECE-Theory is illustrated by considering two charged masses interacting. There is an electrostatic interaction between the charges, and a gravitational interaction between the masses. On the laboratory scale, the electrostatic interaction is orders-of-magnitude greater than the gravitational interaction. Thus, gravitational interaction has not been measured, on the laboratory scale. In ECE-Theory, the interaction between the electrostatic field and the gravitational field can be controlled by the homogeneous current (of ECE-Theory), which is given in [17]. The homogeneous equation (in tensor form) of ECE-Theory is;

∂_{μ}F^{μv}=j^{v}/∈₀
Where;
   F→electromagnetic field tensor
   j→homogeneous current density
   μv→spacetime indices
   ∈₀→vacuum permeability
      given in [19]. It is shown in [17], that for a given initial driving voltage, the effect of the interaction of the electromagnetic field with the gravitational field is significantly amplified (as is the effect of the electromagnetic field on the Newtonian force), in a direction opposite to the gravitational field. As shown in [17], the inhomogeneous current is derived from the covariant Coulomb Law. When the potential energy of the interaction resonates with the background potential energy of spacetime, SCR is achieved. At SCR, amplification of the potential of the interaction term occurs in a direction opposite to gravitation. This produces a counter-gravitation effect.

### 2.2.1 Power Generation with SCR

The application of crossfield technology, presented in this white-paper, is the generation of power by transferring background electric potential energy of spacetime to power electric devices & systems. The transfer of electrical energy (in volts) from the background potential energy of spacetime is accomplished by using the principles of ECE-Theory to tap this background potential energy. It is shown in [18] that (once SCR is achieved) the spin connection diverges (i.e. ∇·ω≠0) in a region between two counter-rotating magnetic fields. This is shown in FIGS. 13 & 14 of [18]. This divergence acts as a source of electric energy/voltage. As is also shown in [18], inserting a dielectric material at the divergence point, permits the resulting voltage to be transferred to power an electric load. Thus, FIG. 13, of [18] is a generic power source configuration (i.e. crossfield generator).

### 2.3 Generic Principles

### 2.3.1 Basic Physical Laws

### Under ECE-Theory

Considering the Coulomb Law under ECE-Theory, from [19] we have;

∇·E=ρ/∈₀
Where: E=−∂A/∂t−∇Φ−ω₀A+wΦ

∇·(−∂A/∂t−∇Φ−ω₀A+ωΦ)=ρ/∈₀

In spherical coordinates we have the resonance equation 14.32 of [17]

d²Φ/dr²+(1/r−ωᵢₙₜ)dΦ/dr−(1/r²+ωᵢₙₜ/r)Φ=−ρ/∈₀
Where; ωᵢₙₜ→the interaction spin connection
   Considering the Poisson equation {∇²Φ=−ρ/∈₀} of the Standard Model, and introducing the vector spin connection ω of the ECE-Theory, one has the following:

∇·(−∇Φ+ωΦ)=−ρ/∈₀ The ECE Poisson equation

∇²Φ−ω·∇Φ−(∇·ω)Φ=−ρ/∈₀ 9.6 of [20]

This equation, 9.6 of [20], has resonance solutions. From the ECE-Theory and [15], it is shown that the gravitational field curves spacetime. It is also shown that the electromagnetic field curves spacetime, but by spinning spacetime.

### 2.3.1.1 Magnetic Levitation (Mag-Lev)

The equivalence of gravity and electromagnetism has been established in references [6] and [7]. The process of magnetic levitation (mag-lev) is described in ([11]-[12]). This mag-lev process, where;

M_{B}=>strength of base magnet

M_{L}=>strength of levitation magnet
(usually attached to a vehicle, such as a mag-lev train)
   is equivalent to the counter-gravitation process presented in this document. The force between the base (M_{B}) and the vehicle (M_{L}) is referred to as the heave-force h, in mag-lev applications. The heave-force neutralizes gravity locally. This is a manifestation of spacetime curvature, and one has the following;

h=h(M_{B},M_{L})
Let: [symbol] = [symbol] (M_{B}, M_{L}) be a velocity along a geodesic Before deriving an elementary set of equations-of-motion for [symbol] , it is useful to summarize the invention. In a generalized mag-lev application, the base-magnet M_{B} and the lev-magnet M_{L} are both used to levitate matter in an anti-gravity region (between M_{L} and M_{B}) resulting from the interaction of the magnetic fields of M_{L} and M_{B}.

The heave-force h is now used to derive an expression for [symbol] (M_{B}, M_{L}).

### 2.3.1.1.1 Equations of Motion

The Ricci Tensor (in terms of M_{L} and M_{B}) can define the heave-force/induced-curvature of the mag-lev effect resulting from M_{L} and M_{B}. From document [10], (noting that a vector is a tensor of rank 1), one has the expression

h=μ₀I²β/2πz=Fₕ
where:
   β=coil length
   I=current
   μ =a magnetic constant

Fₕ=μ₀I²f(D/φ) is the heave force description
where:
   D=a magnet dimension (electric flux density)
   φ=separation of M_{B} (base) and M_{L} (lev-vehicle)

F_{g}=qE+(qv×B) is the EM/gravity description for (Δq) at velocity v.

Fₕ≡F_{g}, μ₀I²f(D/φ)=qE+(qv×μH)
where:
   H=B/μ
   qE+(qv×pH) is the Lorentz Force law
      Again from document [10], F is defined as follows;

F=M_{L}M_{B}/r² (where r is the distance between magnets M_{L} and M_{B})

If F and R_{μv} are both expressions of spacetime curvature, one has the following;

$$\begin{matrix}{M}_{L} {M}_{B} \int d t / {r}^{2} = {h}_{v} \\ = \end{matrix}$$

With an expression for [symbol] in terms of M_{L} and M_{B}, it is possible to define a set of “equations-of-motion”.

### Definitions:

[symbol] —the (M_{L} and M_{B} induced curvature) geodesic path velocity of a vehicle

∫ [symbol] dt—position (along the induced curvature) geodesic path

d [symbol] /dt—acceleration (along the induced curvature) geodesic path

The curvature induced by M_{L} and M_{B} is equivalent to the heave-force h (i.e. mag-lev effect) induced by M_{L} and M_{B}. This defines a simple set of equations-of-motion for geodesic-fall.

### 2.3.1.1.1.1 Equations-of-Motion Conclusions

Gravitation and Electromagnetism are respectively the symmetric and antisymetric parts of the Ricci Tensor, within a proportionality factor. Gravitation and electromagnetism are both expressions of spacetime curvature. Thus the mag-lev heave-force is also an expression of spacetime curvature, and h and [symbol] are arguably equivalent.

Obviously, a more rigorous derivation can lead to a fully comprehensive set of equations-of-motion. These equations-of-motion can be the basis for a propulsion system, based on the induced curvature of spacetime. It is expected that the above derivation and many of its attendant ramifications will be understood from the forgoing, and it will be apparent that various changes may be made in rigor and detail of the derivation, without departing from the spirit and scope of the derivation or sacrificing all of its advantages, the above derivation merely being an example thereof.

### 2.3.1.1.2 Example Propulsion System

### Geodesic-Fall

Gravity is a manifestation of the curvature of spacetime. Due to the equivalence of gravity and electromagnetism (i.e. gravitation and electromagnetism are respectively the symmetric and antisymetric parts of the Ricci Tensor), electromagnetism is also a manifestation of spacetime curvature. Thus, by “proper use” of electromagnetism, spacetime curvature can be induced. Mag-lev technology is an example of this. The term, “proper use”, herein means specific configurations of electromagnetic forces can produce/induce desired curvature of spacetime.

A geodesic is defined in [2], as a curve uniformly “parameterized”, as measured in each local “Lorentz frame” along its way. If the geodesic is “timelike”, then it is a possible world line for a freely falling body/particle.

As stated in [2], free fall is the neutral state of motion. The path through spacetime, of a free falling body, is independent of the structure and composition of that body. The path/trajectory of a free falling body is a “parameterized” sequence of points (i.e. a curve). The generalized coordinate qᵢ is used to label/parameterize each point. Generally, qₜ refers to time. Thus, each point (i.e. parameterized point) is an “event”. The set of events (i.e. ordered set of events) is the curve/trajectory of a free falling body. In a curved spacetime, these trajectories are the “straightest” possible curves, and are referred to as “geodesics”. The parameter qₜ (defining time) is referred to as the “affine parameter”.

A Lorentz frame, at an “event” (∈₀) along a geodesic, is a coordinate system, in which

g_{μv}(∈₀)≡η_{μv}

and g_{μv}≈η_{μv} in the neighborhood of ∈₀,
where:

$$μ ⇒ translation coordinate$$

$$v ⇒ rotation coordinate$$

$${η}_{μ v} ⇒ Minkowski Tensor ⇒ \{ \begin{matrix}1 ⇒ μ = v = 1 , 2 , 3 \\ - 1 ⇒ μ = v = 0 \\ 0 ⇒ μ \neq v\end{matrix} \\ {g}_{μ v} ⇒ metric tensor$$

The relationship between two points/events can be spacelike or timelike. The spacetime interval between two events ∈ᵢ, ∈ⱼ is given by;

dτ²=dt²ᵢ−(1/c²)d∈ᵢ²=dt²ⱼ−(1/c²)d∈ⱼ²

dσ²=d∈²ⱼ−c²dtᵢ²=d∈²ⱼ−c²dtⱼ²

Depending on the relative magnitude of dt and d|∈|/c, dτ or dσ will be real-valued. If dτ is real, the interval is timelike. If dσ is real, the interval is spacelike. The degree of curvature can determine the relationship between points/events along a geodesic, resulting from such curvature. Thus, curvature defines a geodesic. A given curvature of spacetime produces a set of geodesics. A properly controlled particle (or vehicle) can “fall” along a given geodesic. For vehicular motion along a geodesic, “proper control” is defined as the “relative configuration control” of electromagnetic sources that are hosted by said vehicle. A “dynamic” configuration control could serve as a means of vehicular control & navigation in fall motion along a geodesic resulting from induced spacetime curvature. Such motion is referred to as geodesic-fall [symbol] . The horizontal instability of the LEVITRON device is an example of uncontrolled [symbol] . The magnetic sources properly attached to a vehicle could cause said vehicle to move (i.e. fall) along the geodesic path induced by the anti-gravity region. This process can be observed as the Levitron top falls away from its base, when the top's angular momentum slows below the minimum required for stability [11, 23].

The properties of geodesic-fall are determined by the degree of spacetime curvature. The motion of a particle/vehicle along a geodesic (in curved spacetime) depends on the degree of curvature enabling that geodesic. The velocity vector [symbol] (under induced spacetime curvature) is dependent on the “degree” of that induced curvature. Thus, [symbol] is not constrained by c (the speed of light in normal/our spacetime). The velocity vector [symbol] is constrained only by the magnitude and configuration of the sources inducing the spacetime curvature.

It is important that one not come to the erroneous conclusion that Geodesic-Fall involves moving a vehicle by magnetic forces. The Geodesic-Fall concept is a secondary effect resulting from induced spacetime curvature.

### 2.3.1.1.3 Levitron-Like Device Dynamics

ECE-Theory easily explains the Levitron. Thus, the Levitron can be viewed as a demonstration-device for ECE-Theory. The Levitron employs counter-rotating magnetic fields to achieve its counter-gravity effect. It falls in the class of devices defined in [18]. Using the Levitron as a conceptual basis, the focus is levitron-like devices, which are described in [12]. The Levitron is shown herein to be a rudimentary sub-class of crossfield-device technology.

### 2.3.1.1.3.1 A Note on Counter-Rotation

We note once again that, for the Levitron, M₁ is attached to the top (s), M₂ is the base. Device operation shows the top must spin to levitate stably above the base. More correctly, M₁ is required to spin.

### Let:

v_{M1},v_{M2}→rotational velocities of the magnets for counter-rotation(v_{M1}+v_{M2})→vᵣ relative velocity.

If v_{M2}=0, then we have the Levitron case. For levitation, vᵣ must be positive. Thus, one argues the Levitron top must spin. However, it is M₁ that is required to spin.

It is useful to note that the explanations of the Faraday disk generator [24], are similar to those of this section. The explanations of the Faraday disk (homopolar) generator incorporate ECE-Theory. It has been fully explained by ECE-Theory.

### 2.3.1.1.3.2 The Spin/Rotation Requirement

For the Levitron, a spin component is needed to couple with spacetime torsion, to achieve spin-connection-resonance (SCR). This spin component must exceed some β to maintain SCR and stability. Stated more precisely, from the above discussion;

vᵣ≧β→stability of top above the base

vᵣ<β→instability of top, causing it to fall

If the Levitron's v_{M1} spin/rotation component is less than β, the top falls away along a geodesic path induced by the anti-gravity condition caused by the interaction of the Levitron's ring magnet (M₁), and magnetic base (M₂). This factor is exploited as a propulsion system concept in [23].

### 2.3.1.1.3.2.1 Quantitative Analysis Using ECE-Theory

Starting with the ECE Poisson equation:

∇·(−∇Φ+ωΦ)=−ρ/∈₀

∇²Φ−ω·∇Φ−(∇·ω)Φ=−ρ/∈₀ 9.6 of [20]

From section 4.3 of [25], we have the following;

(∇μ₁(t)·B₁(r)+∇μ₂(t)·B₂(r))=Φ_{λ}

From [6] we have the following resonance equation;

d²Φ/dr²+(1/r−ωᵢₙₜ)dΦ/dr−(1/r²+ωᵢₙₜ/r)Φ=−ρ/∈₀ 14.32 of [17]
Where; ωᵢₙₜ→the interaction spin connection
   From Coulombs Law ∇·E=ρ/∈₀, one also has E=−∇Φ. Using Φ_{λ} one has the following;

∇²Φ_{λ}=ρ/∈₀ (where Φ_{λ} is the driving function)

The driving function Φ_{λ} determines the degree of induced curvature F(μᵢ, Bᵢ). Let;

(∇μ₁(t)·B₁(r)+∇μ₂(t)·B₂(r))=Φ_{λ} (1) ∇(μ₁(t)·B₁(r))+∇(μ₂(t)·B₂(r))=M₁(r)+M₂(r)=

dΦ_{λ}/dr=dM₁/dr+dM₂/dr (2)

d²Φ_{λ}/dr²=d²M₁/dr²+d²M₂/dr² (3)

substituting in 14.32 of [17], one has the following;

−ρ/∈₀=(d²M₁/dr²+d²M₂/dr²)+(1/r−ωᵢₙₜ)(dM₁/dr+dM₂/dr)−(1/r²−ωᵢₙₜ/r)(M₁(r)+M₂(r)) (4)

−ρ/∈₀=d²M₁/dr²+d²M₂/dr²+dM₁/rdr−ωᵢₙₜdM₁/dr+dM₂/rdr−ωᵢₙₜdM₂/dr−M₁/r²−M₁ωᵢₙₜ/r−M₂/r²−ωᵢₙₜM₂/r (5)

From section 4.1 of [25], we use the expression derived for H, the geodesic-fall path velocity of a vehicle;

$${M}_{1} {M}_{2} / {r}^{2} \approx = {T}_{μ v} = H$$

We then have the following;

$$\begin{matrix}{M}_{1} \approx - {r}^{2} {T}_{μ v} / {M}_{2} \\ \frac{d {M}_{1}}{d r} \approx - r {T}_{μ v} / 2 {M}_{2} \\ \frac{{d}^{2} {M}_{1}}{d {r}^{2}} \approx - {T}_{μ v} / 2 {M}_{2}\end{matrix} \} substituting into eq . ( 5 )$$

after some algebraic simplification, one has the following;

d²M₂/dr²+(1/r−ωᵢₙₜ)dM₂/dr+ωᵢₙₜKT_{μv}(r+2)/2M₂−(M₂+rM₂ωᵢₙₜ)/r²=−ρ/∈₀d²M₂/dr²+(1/r−ωᵢₙₜ)dM₂/dr−(1+rωᵢₙₜ)M₂/r²=−ρ/∈₀+Constant (6)
Equation (6) is a resonance equation in M₂
   An expression for a resonance equation in M₁, can also be derived in a similar manner. Considering the ECE Poisson equation;

∇²Φ−ω·∇Φ−(∇·ω)Φ=−ρ/∈₀

Arguably, SCR can be achieved relative to M₁, M₂, or Φ. The counter-rotation of M₁ and M₂ is needed to amplify Φ via SCR. This provides the counter-gravitation effect, and is thus the reason why the magnet (M₁), must spin, if counter-gravitation is to be maintained. This is a direct consequence of ECE-Theory.

### 2.3.1.1.4 Generalized (Alternative Counter-Rotation) Case

Here we take the special Levitron case and generalize to the generic CFD. For the generic case, M₁ is attached to the top (s), M₂ is the base. A generalization of this concept is an object (e.g. a top) spinning between the M₁ and M₂ magnetic sources. If the object is magnetized (i.e. M₃), one has M₃ rotating relative to M₁, and M₃ rotating relative to M₂ simultaneously. Thus, counter-rotation of M₃ and M₁, and of M₃ and M₂ is realized. This results in levitation of the object. Analytically, from section 2.3.1.1.3.1 above, where;

v_{M1},v_{M2}→rotational velocities of the magnetic sources

v_{M3}→rotational velocity of the object

If v_{M1}=v_{M2}=0, and v_{M3}>0, anti-gravity sub-regions are produced between (counter-rotating) M₃ and M₁, and between (counter-rotating) M₃ and M₂, causing the object to levitate. This is a basic initial configuration of the invention.

### 2.3.1.1.4.1 Control of Object Dynamics

Advanced application of the crossfield-device [23, 25] could require a means to control the dynamics of the levitated object, for example; if the levitated object was a vehicle of some type. The anti-gravity sub-regions would control the dynamics of the levitated object, in the same “conceptual” manner that aerodynamic lift is used to control the dynamics of an aircraft. As an example; the intensity of the sub-region between M₃ and M₂ could be used to control the degree of levitation.

### 2.4 Invention Structure & Configuration

The basic structure of the invention is two counter-rotating magnetic sources mounted on a stand, which separates the magnetic sources by a given space, such that a counter-gravitational region is induced in said space. The fundamental configuration of this structure is shown in FIG. 4. Matter in this induced counter-gravitational region levitates, or in other words behaves as matter in a zero-gravity environment, such as outer-space. Other configurations of the invention are show in FIGS. 4 thru 6. In these applications (usually large type applications), the matter inside the induced counter-gravitational region can serve as the stand, for the magnetic sources. More precisely, the magnetic sources are attached to the levitated matter.

### 2.4.1 The Magnetic Sources

It is important to note that the invention's magnetic sources do not have to be permanent magnets. The magnetic sources can range from electromagnets to electromagnetic-arrays, to IFE (Inverse Faraday Effect) [21, 22] induced type magnetic sources.

### 2.4.2 Operational Considerations

Considering the structure of the invention, the expressions for the torque forces due to the M₁ and M₂ magnetic sources in tangent space [symbol] ,

[symbol]

=μ₁(t)×B₁(r), [symbol] =μ₂(t)×B₂(r)

Given base vectors eₘ₁, eₘ₂ defining a tangent space to [symbol]
where; [symbol] →“bubble”, an arbitrary base manifold

e′ₘ₁= [symbol] ₘ₁^{m2}eₘ₂

coordinate system of M₁ rotates relative to coordinate system of M₂

e^{ik}q^{m1}= [symbol] ₘ₁^{m2}q^{m2}

from ECE-Theory

Aₘ₁^{m2}=A⁰ [symbol] ₘ₁^{m2}

Interpreting the anti-gravity effect at [symbol] , as a field of force (characterized by the coordinate system of [symbol] rotating with respect to [symbol] ), and another field of force (characterized by the coordinate system of [symbol] rotating with respect to [symbol] ). These forces are additive if the magnetic sources M₁ and M₂ are counter-rotating. This is a cursory (but more fundamental) argument for counter-rotation of M₁ and M₂ magnetic sources.

### 2.4.3 Ramifications of Video Demonstration

By the process defined in [12, 17, 18, 24], an SCR condition was established by the counter-rotation between the spinning top M₃ and the stationary magnetic fields M₁ and M₂. The potential energy Φ was amplified [eq. 14.32, of [17]]. Anti-gravity regions were established above and below the spinning top. This caused the magnetized top to levitate, as shown in [24]. As the rotation (spin vector) of the top degrades below the equilibrium value, the top falls away along the geodesic path induced by the counter-rotating magnetic fields M₁, M₂, and M₃. This fall-away is the conceptual basis for the Geodesic-Fall/Curvature-Drive propulsion system concept.

It is important to note that the demonstration video [24] was conducted with simple, readily available commercial components. The demonstration was conducted on a desktop, in a non-laboratory environment. These factors further attest to the validity and strength of the concepts, and reproducibility of the demonstration.

### 2.5 Conclusions

Several concepts are presented in this application, which will appear alien to those not versed in, or unable to grasp ECE-Theory, which requires an understanding of the fundamentals of Einstein's Theory of Relativity, and Cartan Geometry. However, the discussions in this document should be comprehendible to any “competent” undergraduate physics student. Sections 1 and 2 of this application include introductions to basic scientific concepts involved with the invention. An elementary introduction to ECE-Theory is also provided. As an example, the Light Gauge Theory of section 1.2.2.1 is a generalized derivation of Special Relativity, wherein Einstein's assumption that the speed-of-light (c) is the maximum achievable velocity, is removed. The Light Gauge Theory should not be foolishly interpreted as a play on mathematics with no scientific basis.

### 2.5.1 Electromagnetism and Gravitation

Spacetime curves and spins. This has been shown in several scientific works, such as [7] and [15]. The spin of spacetime is referred to as torsion. Electromagnetism is the torsion of spacetime. Gravitation is the curvature of spacetime. Einstein neglected torsion in his Theory of Relativity. Thus, the Theory of Relativity is incomplete. Einstein spent his later years, unsuccessfully trying to expand Relativity into a unified field theory. ECE-Theory successfully accomplishes this. Torsion can be viewed as a form of curvature. Thus, in the generic sense, one can state that both electromagnetism and gravitation are manifestations of spacetime curvature. This leads to the obvious conclusion that the speed-of-light (c) is a function of spacetime curvature. This, however, would be alien to anyone intellectually constrained by the old Relativity Theory.

### 2.6 Prior Art

Previous endeavors in electromagnetic based propulsion were focused on mag-lev technology. High-speed trains are principal applications. The train/vehicle contains the magnet (referred to in this document as) M_{L}. The track/guideway generally contains the base magnet M_{B}. The heave-force is generated by mutual repulsion of M_{L} and M_{B}. This reduces friction and provides dynamic characteristics similar to air-cushioned hovercraft type vehicles. Propulsion of mag-lev trains is generally achieved by creating a traveling magnetic wave in the guideway/base. This traveling wave pulls M_{L} along in the horizontal plane, thus providing propulsion. The process presented in this document uses only an equivalent heave-force, for both propulsion and control.

The LEVITRON device is a toy top that can be made to spin while levitated above a magnetic base. Some West Coast toy companies market the toy. Physical principles governing the LEVITRON are similar to those exploited by the geodesic-fall process. The LEVITRON device is arguably a “miniaturized” example of a mag-lev like process. Aspects of the LEVITRON device behavior are used herein to illustrate the geodesic-fall process dynamics, on the laboratory scale.

### 3. BRIEF DESCRIPTION OF DRAWINGS

FIG. 1 Prior Art LEVITRON device basic configuration

FIG. 2 A Generic anti-gravity device/Crossfield-Device configuration

FIG. 3 Crossfield-Device (CFD) using 3 magnetic fields

FIG. 4 Initial Lab-Scale Crossfield-Device (CFD) (anti-gravity sub-regions)

FIG. 5 Advanced Crossfield-Device Configuration: Vehicular Architecture (rotating magnetic fields attached to object/vehicle)

FIG. 6 Laboratory-scale CFD (Working Model) in Operation

### 4. DETAILED DESCRIPTION OF INVENTION

The invention has several fundamental embodiments which are described in the following sections. Other embodiments are derived from these fundamental embodiments.

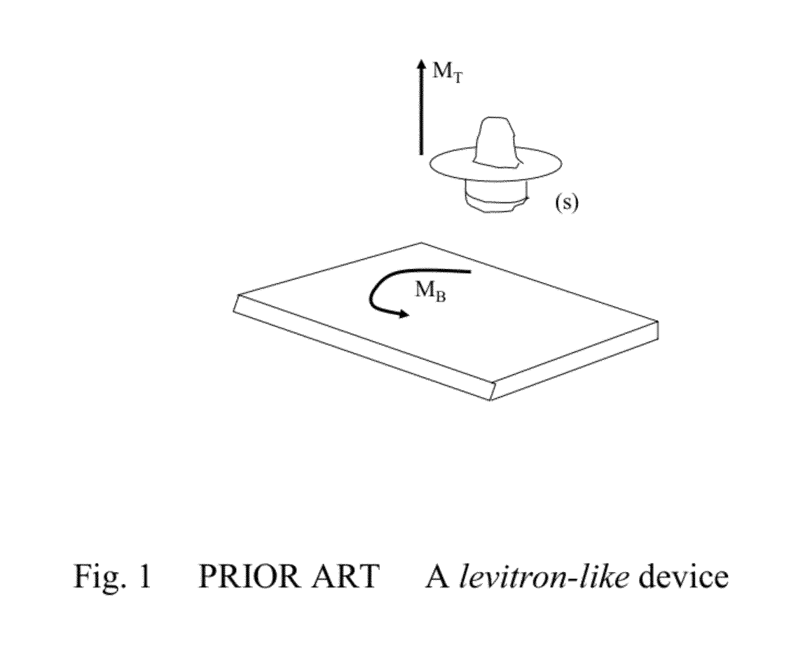

Regarding FIG. 1, the basic configuration of the LEVITRON device is illustrated. It (the LEVITRON) consists of a top (s), a magnet (M_{L}) attached to the top, and a base which is/contains the magnet (M_{B}). The top can be made to spin, while levitated above the base. The spin of the top is necessary to maintain the levitated equilibrium. If the top were not spinning, the force of magnetic torque (from M_{B}) on M_{L} would force the top to turn over, thus destroying equilibrium and stability. These principles are explained in [12]. Generally the spin of the top causes the torque to “precess” around the direction of the vertical heave-force h resulting from the natural repulsion of M_{L} and M_{B}. This “precession”, about the force h, prevents the top from overturning and preserves equilibrium and stability. Equilibrium and stability are lost when the top's rpm falls below a stability value. The top then tends to fall (out of equilibrium, to the left or the right) to the floor. This fall is an example of uncontrolled geodesic-fall, as the path of fall is determined by the relative configuration of M_{L} and M_{B} at the time of instability.

The spin rpm degradation is due primarily to friction and other mechanical forces.

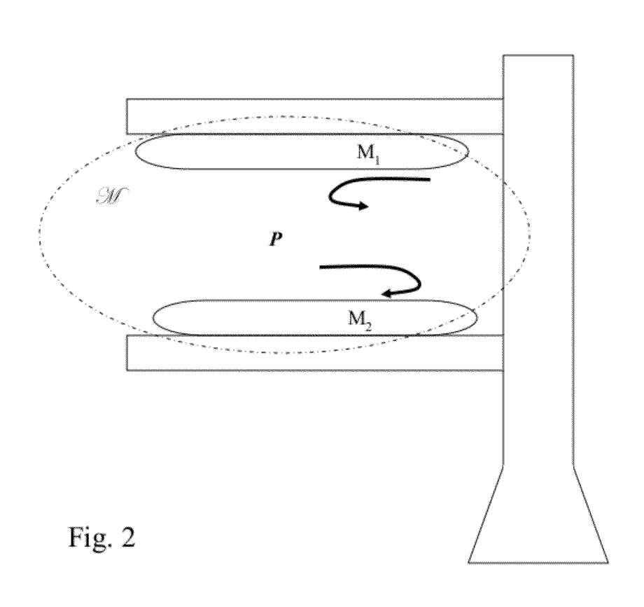

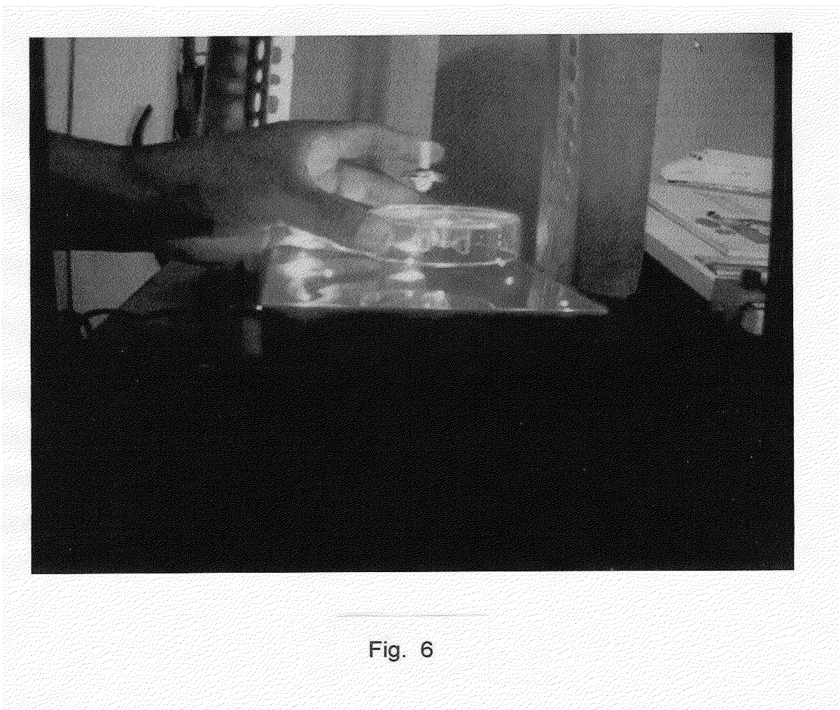

Referencing FIG. 2, a device configuration (suitable for laboratory-scale usage, or full size applications) is illustrated. The purposes of this device are production of electric energy and production of anti-gravity conditions. The device can be used to demonstrate SCR, to refine methods of attaining SCR, and to examine SCR related conditions. The device can be implemented on the laboratory-scale, or up-scaled for real applications. The device consists of two magnetic fields (M₁ and M₂), counter-rotating to produce anti-gravity region ( [symbol] ) between them. At point p, the spin connection divergence is non-zero (i.e. ∇·ω≠0), and SCR is achieved, amplifying the background electric potential energy of spacetime [17]. At SCR the effect of the electric field on gravitation is maximized in a direction opposite to the gravitational field, [17, 18]. This creates an anti-gravity effect. This effect is shown in FIG. 6, by the levitation of the spinning top.

Sources for these boundary magnetic fields can be implemented as magnetic disks or as arrays of electromagnetic elements. Control mechanisms, are used to control each of the magnetic sources. If a magnetic source is implemented as a simple magnetic disk, its control mechanism can be a simple rotary motor. In this case, the magnetic source, and control mechanism, can be connected by a simple shaft, as indicated by the dark vertical line between device-components. If a magnetic source is implemented as an array of electromagnetic elements, its control mechanism controls the activation/deactivation sequence and field strength of the array elements. This element activation/deactivation sequence is such as to generate a “virtual rotation” of the magnetic source. A single device could employ both types of implementation, depending on application and operational requirements.

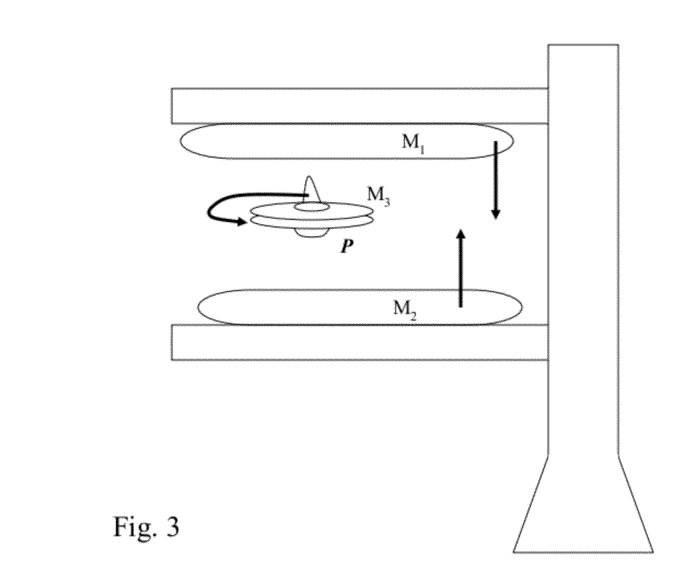

Regarding FIG. 3, a crossfield-device employing 3 magnetic fields (M₁, M₂, M₃) is shown. This device can be used to become familiar with the crossfield device technology. A simple experiment (defined below) can be performed. This experiment will permit fellow scientists & engineers to further examine the crossfield technology. Further, potential manufacturers & users could gain experience in constructing and operating crossfield device technology. It is the type of rudimentary device used in [26]. M₃ can be considered as a magnetic dipole counter-rotating with static magnetic fields M₁ and M₂, as discussed in [11, 12]. Levitation is achieved/explainable by SCR (M₃ counter-rotating with M₂) in accordance with the counter-rotation concepts of [12, 17]. Thus, the CFD is demonstrated. At point p, the spin connection divergence is non-zero (i.e. ∇·ω≠0), amplifying the electric potential energy of spacetime. This amplification maximizes the effect of the electric field on Newtonian gravitation, in a direction opposite to the gravitational filed, [17]. Also, by placing a dielectric at point p, a power transfer from the background electric potential of spacetime to an electric load is possible [18].

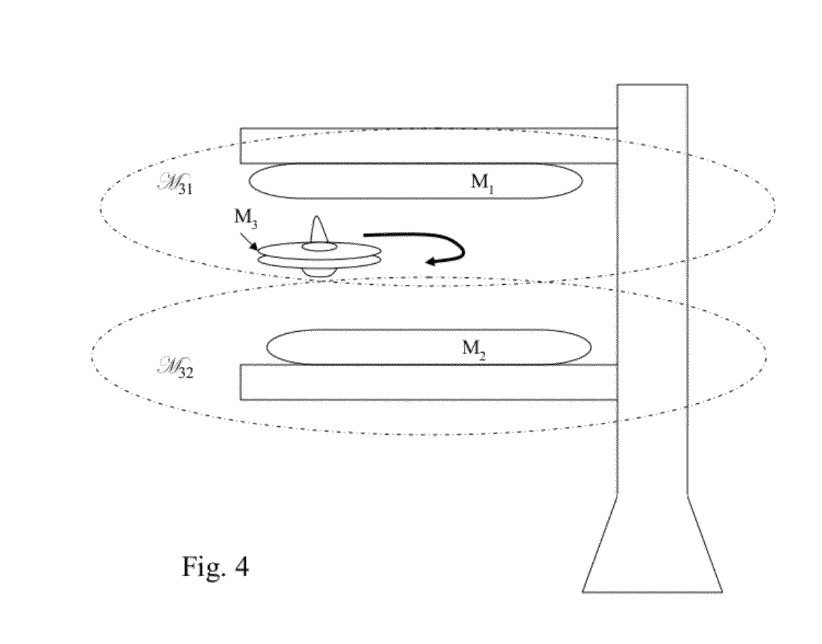

Regarding FIG. 4, a generic lab-scale crossfield-device architecture is illustrated. The boundary magnetic fields M₁ and M₂ are stationary. A third magnetic field M₃ is attached to the levitated object, here a top. Since M₃ is attached, the top is obviously considered magnetized. As defined in sec. 2.2.1.1.4 above, the spinning top creates two anti-gravity sub-regions [symbol] and [symbol] , wherein each sub-region contributes to the levitation of the object (herein, the magnetized spinning top). The relative interaction of the sub-regions ( [symbol] and [symbol] ) can be manipulated to control the dynamics of the levitated object. This factor can be used as the basis for a curvature-based propulsion system, since gravitation and electromagnetism are both manifestations of spacetime curvature, a fundamental principle of ECE-Theory.

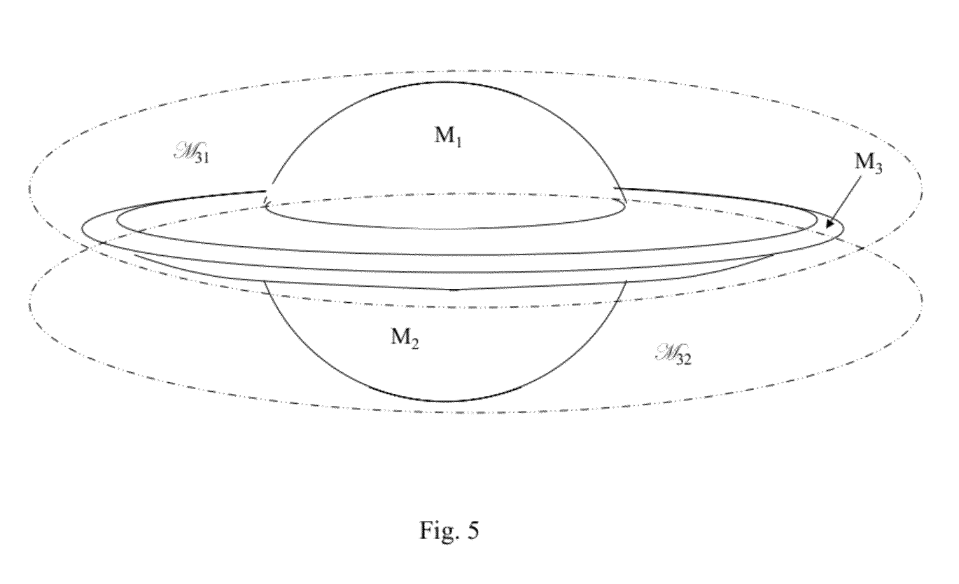

Regarding FIG. 5, considering a propulsion system based on the crossfield-device architecture, a possible configuration is illustrated. The boundary magnetic fields (M₁, M₂) are attached to the object. M₃ is also attached to the object (as in FIG. 4), and spinning. In this illustration, the object is a vehicle of some type. Depending on desired vehicle dynamics, M₁ or M₂ could be rotating, in such manner as to establish desired anti-gravity sub-regions ( [symbol] and/or [symbol] ) for dynamic control of the object/vehicle.

Regarding FIG. 6, a levitated object (e.g. magnetized spinning top) is illustrated in a still-frame from the demonstration video [24] of a working model crossfield-device (CFD). The working model is an initial laboratory-scale version of a CFD described in FIG. 4.

It is expected that the present invention and many of its attendant advantages will be understood from the forgoing description and it will be apparent that various changes may be made in form, implementation, and arrangement of the components, systems, and subsystems thereof without departing from the spirit and scope of the invention or sacrificing all of its material advantages, the forms hereinbefore described being merely preferred or exemplary embodiments thereof.

The foregoing description of a preferred laboratory-scale embodiment of the invention has been presented to illustrate the principles of the invention and not to limit the particular embodiment illustrated. It is intended that the scope of the invention be defined by all of the embodiments encompassed within the following claims and their equivalents.

What is claimed:

1. A method for generating an anti-gravity region around an object (by counter-rotating magnetic fields) causing said object to levitate in such manner as matter would levitate in a gravity-neutral environment, wherein said object can be a particle of matter, or range in size up to a vehicle, whereby said object will fall away from said levitated state, as gravity is restored;

2. The method of claim 1, wherein the means for generating said anti-gravity region consists of counter-rotating two magnetic fields, each on the boundary of said anti-gravity region, wherein said counter-rotating magnetic fields can both be rotating (counter to each other), or one of the magnetic fields can be stationary (relative to the other rotating magnetic field), whereby said anti-gravity region's intensity is a function of the field strength and relative rotation speed of said counter-rotating magnetic fields;

3. The method of claim 2, wherein a third magnetic field counter-rotates with said boundary magnetic fields, wherein said boundary magnetic fields remain stationary, wherein counter-rotation is achieved by the rotation of said third magnetic field (attached to the object being levitated), wherein this counter-rotation method defines a spin requirement for said object, wherein the spin of the object causes the rotation of said third magnetic field attached to said levitated object;

4. A system for generating an anti-gravity region around an object (by counter-rotating magnetic fields) causing said object to levitate in such manner as matter would levitate in a gravity-neutral environment, wherein said object can be a particle of matter, or range in size up to a vehicle, whereby said object will fall away from said levitated state, as gravity is restored, whereby the system is referred to as a crossfield-device;

5. The system of claim 1, wherein the means for generating said anti-gravity region consists of counter-rotating two magnetic fields, each on the boundary of said anti-gravity region, wherein said counter-rotating magnetic fields can both be rotating (counter to each other), or one of the magnetic fields can be stationary (relative to the other rotating magnetic field), whereby said anti-gravity region's intensity is a function of the field strength and relative rotation speed of said counter-rotating magnetic fields;

6. The system of claim 2, wherein a third magnetic field counter-rotates with said boundary magnetic fields, wherein said boundary magnetic fields remain stationary, wherein counter-rotation is achieved by the rotation of said third magnetic field (attached to the object being levitated), wherein this counter-rotation process defines a spin requirement for said object, wherein the spin of the object causes the rotation of said third magnetic field attached to said levitated object;

7. The system of claim 6, wherein said third magnetic field generates an anti-gravity sub-region between itself and said boundary magnetic fields, by counter-rotating with said boundary magnetic fields, wherein said boundary magnetic fields remain stationary, wherein said object is levitated by the anti-gravity sub-regions;

8. The system of claim 7, wherein an anti-gravity sub-region is intensified by rotating a boundary magnetic field in such manner that said rotating boundary magnetic field is counter-rotating with said third magnetic field, whereby controlling the intensity of said intensified anti-gravity sub-region is a process to control the dynamics of said levitated object, in a conceptually similar manner that aerodynamic lift controls the dynamics of an aircraft.
